(19) United States
(12) Patent Application Publication
(10) Pub. No.: US 2011/0060877 A1
(43) Pub. Date: Mar. 10, 2011

(54) EXTERNAL STORAGE DEVICE, CONTROL METHOD FOR COMPUTER SYSTEM, CONTROL METHOD FOR EXTERNAL STORAGE DEVICE, AND COMPUTER PROGRAM PRODUCT

(75) Inventors: Taichi EJIRI, Nagoya-shi (JP); Masahiko HORIBE, Nagoya-shi (JP); Suguru ISHII, Nagoya-shi (JP); Yuko IMAIZUMI, Toyokawa-shi (JP)

(73) Assignee: BUFFALO INC., Nagoya-shi (JP)

(21) Appl. No.: 12/861,676

(22) Filed: Aug. 23, 2010

(30) Foreign Application Priority Data
Aug. 24, 2009 (JP) 2009-192854

(51) Int. Cl. G06F 12/08; H04L 9/32

(52) U.S. Cl. 711/112; 726/28; 711/E12.019

(57) ABSTRACT

When a hard disk drive 200 is initially connected, the CPU 110 of a personal computer 100 assigns respective drive letters to a virtual CD-ROM drive area 222 and a hard disk drive 224 in the hard disk drive 200, and records information relating the drive letter assignments as drive letter information in the registry. The CPU 110 then executes auxiliary application software stored in the virtual CD-ROM drive area 222 to delete and disable assignment of a drive letter to the virtual CD-ROM drive area 222.

### CROSS-REFERENCE TO RELATED APPLICATIONS

The present application claims the priority based on Japanese Patent Application No. 2009-192854, of Buffalo inc. filed on Aug. 24, 2009, the disclosure of which is hereby incorporated by reference in its entirety.

### BACKGROUND

1. Technical Field

The present invention relates to an external storage device for connection to a computer system that includes a display device; to a control method for a computer system; to a control method for an external storage device; and to a computer program.

2. Related Art

External storage devices designed to connect to computer systems have enjoyed widespread use for some time. Some types of external storage devices are furnished with multiple physical or logical storage portions. In one embodiment, a removable media device has a virtual CD-ROM area and a storage area.

When an external storage device with multiple storage portions is connected to a computer system, the computer system recognizes each storage portion as an individual disk drive, and assigns an individual drive letter to each storage portion. Thus, a drive tree and icons representing the multiple disk drives are displayed on the display device of the computer system. The user is then able to view and perform various operations on the drive tree and icons that are displayed on the display device to represent the disk drives (storage portions).

In an external storage device having multiple storage portions, some of the storage portions may store computer programs that are executed only at specific times, for example when the external storage device is initially connected to a computer system, and that after being executed once are substantially never executed thereafter. Examples of such programs are an installer for application software, and utility software for configuring initial settings of the external storage device. In such instances, where a drive tree and icons representing storage portions that store computer programs which are virtually never used are displayed on the display device of the computer system, the user viewing and attempting to perform various operations may experience poor ease of use.

An advantage of some aspects of the invention is to ameliorate cumbersome operation for the user when presented with display of a drive tree and icons representing multiple storage portions on a display device when an external storage device containing the storage portions is connected to a computer system that includes the display device.

### SUMMARY

The present invention is addressed to attaining the above objects at least in part according to the following aspects of the invention.

According to one aspect of the invention, there is provided:

An external storage device for connection to a computer system, comprising:

a first storage portion storing a first computer program; and

a second storage portion, wherein

the first computer program is to be executed by the computer system after a first drive letter is assigned to the first storage portion by the computer system, and

the first computer program includes:

a portion for directing the computer system to automatically delete the first drive letter assignment for the first storage portion without a Delete instruction by a user at prescribed timing while the external storage device is connected to the computer system.

In addition to the aspect of an external storage device described above, the present invention may assume the aspect of a control method for a computer system including a connected external storage device, or a control method for an external storage device. Additional possible aspects include a computer program for realizing the above, a recording medium having the computer program recorded thereon, or a data signal containing the program and carried on a carrier wave. The supplemental elements shown above may be implemented in these respective aspects as well.

Where the present invention is provided as a computer program or a recording medium having the computer program recorded thereon, it may constitute the entire program for controlling operations of the external storage device or of the computer system storing the external storage device, or only that portion used to carry out the functions of the present invention. Various computer-readable media may be employed as the recording medium, such as a flexible disk, CD-ROM, DVD-ROM, magnetooptical disk, IC card, ROM cartridge, printed matter imprinted with symbols such as a bar code, computer internal memory devices (memory such as RAM and ROM), and external memory devices.

These and other objects, features, aspects, and advantages of the present invention will become more apparent from the following detailed description of the preferred embodiments with the accompanying drawings.

### BRIEF DESCRIPTION OF THE DRAWINGS

FIG. 1 depicts the general features of a computer system according to a first embodiment of the invention;

FIG. 2 is a flowchart illustrating the flow of a process executed by a CPU 110 of a personal computer 100 when a hard disk drive 200 is initially connected to the personal computer 100;

FIG. 3 is a flowchart illustrating the flow of a process executed by the CPU 110 of the personal computer 100 when initial configuration application software is run the second or subsequent time, with the hard disk drive 200 connected to the personal computer 100;

FIG. 4 depicts the general features of a computer system according to a second embodiment of the invention;

FIG. 5 is a flowchart illustrating the flow of a process executed by the CPU 110 of the personal computer 100 when a hard disk drive 200A is connected to the personal computer 100;

FIG. 6 depicts the general features of a computer system according to a third embodiment of the invention;

FIG. 7 is a flowchart illustrating the flow of a process executed by the CPU 110 of the personal computer 100 when a hard disk drive 200B is initially connected to the personal computer 100;

FIG. 8 is a flowchart illustrating the flow of a process executed by the CPU 110 of the personal computer 100 when the hard disk drive 200B is accessed the second or subsequent time;

FIG. 9 depicts the general features of a computer system according to a fourth embodiment of the invention; and

FIG. 10 is a flowchart illustrating the flow of processes executed by the CPU 110 of the personal computer 100 and by the CPU of a controller 210C of a hard disk drive 200C when the hard disk drive 200C is initially connected to the personal computer 100.

### DESCRIPTION OF EXEMPLARY EMBODIMENT

A fuller understanding of the aspects of the invention is provided by the following description of the embodiments.

### A. First Embodiment

### A1. System Configuration

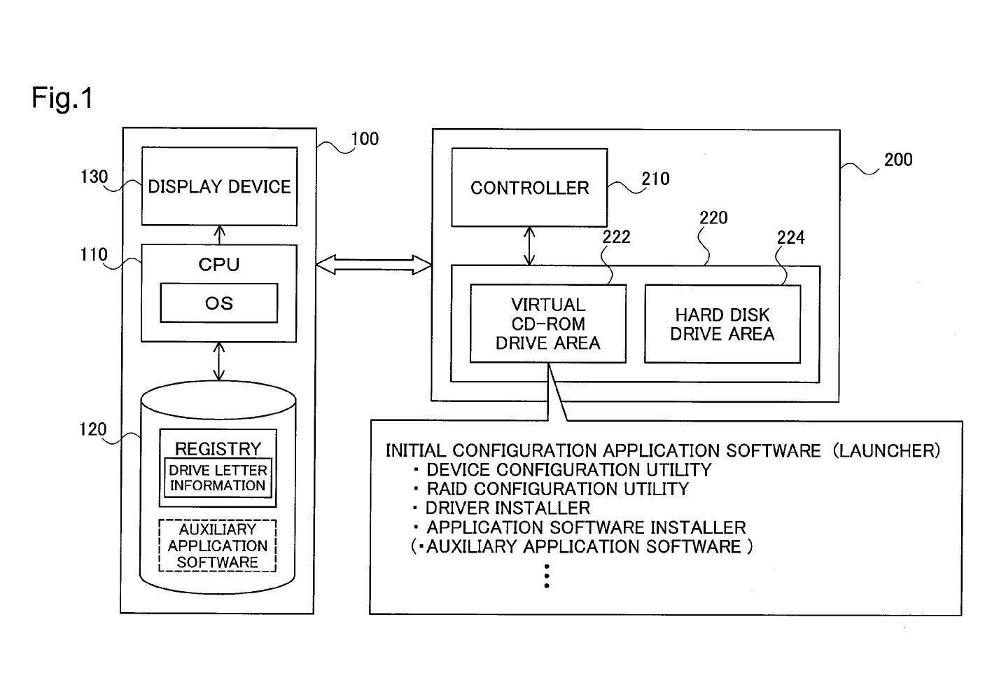

FIG. 1 depicts the general features of a computer system according to a first embodiment of the invention. This computer system includes a hard disk drive 200 having a cable connection to a personal computer 100 through a USB (Universal Serial Bus) cable for example.

The personal computer 100 includes a CPU 110, a hard disk drive 120, and a display device 130. Under the management of the operating system (OS), the CPU 110 performs overall control of the personal computer 100 and executes different application software. The personal computer 100 corresponds to the computer system recited in the Summary.

The hard disk drive 200 includes a controller 210 and a storage portion 220. The controller 210 is furnished with a CPU, RAM, ROM and so on (not shown), and controls reading of data from the storage portion 220 and writing of data to the storage portion 220 (hard disk drive area 224). The storage portion 220 is composed of several hard disks, and includes a logically partitioned virtual CD-ROM drive area 222 and a hard disk drive area 224. The virtual CD-ROM drive area 222 is recognized as a CD-ROM drive by the personal computer 100 when the hard disk drive 200 is connected to the personal computer 100. The personal computer 100 then assigns a drive letter (e.g. “F:”) to the virtual CD-ROM drive area 222. The hard disk drive area 224 is recognized as hard disk drive by the personal computer 100 when the hard disk drive 200 is connected to the personal computer 100. The personal computer 100 then assigns a drive letter (e.g. “G:”) to the hard disk drive area 224. A drive tree and icons representing the CD-ROM drive (virtual CD-ROM drive area 222) and the hard disk drive (hard disk drive area 224) are then displayed on the display device 130. The hard disk drive 200 corresponds to the external storage device recited in the Summary.

Application software for use in initial configuration is stored in the virtual CD-ROM drive area 222. This initial configuration application software is discussed later. The initial configuration application software is loaded and run by the CPU 110 of the personal computer 100 at a specific time, for example, when the hard disk drive 200 is initially connected to the personal computer 100. Once the initial configuration application software is executed, it is substantially never executed again thereafter.

The initial configuration application software includes, for example, a device configuration utility, a RAID (Redundant Arrays of Inexpensive Disks) configuration utility, a driver installer, an application software installer, and so on; these are run through the agency of a launcher designed to run them. When a drive letter is assigned to the virtual CD-ROM drive area 222 by the personal computer 100, the launcher runs automatically through the Auto-Run feature of the OS. The initial configuration application software also includes auxiliary application software; as discussed later, this auxiliary application software installs automatically onto the hard disk drive 120 of the personal computer 100 when the virtual CD-ROM drive area 222 is initially assigned a drive letter by the personal computer 100. The functions of the auxiliary application software are discussed later. The virtual CD-ROM drive area 222 corresponds to the first storage portion recited in the Summary. The auxiliary application software included in the initial configuration application software corresponds to the first computer program recited in the Summary. The device configuration utility, RAID configuration utility, a driver installer, an application software installer, etc. included in the initial configuration application software correspond to the second computer program recited in the Summary. In the present embodiment, the virtual CD-ROM drive area 222 also stores drivers and application software for installation on the personal computer 100 by the installers that are included in the initial configuration application software.

The hard disk drive area 224 is used as a rewritable area. The hard disk drive area 224 corresponds to the second storage portion recited in the Summary.

### A2. Process

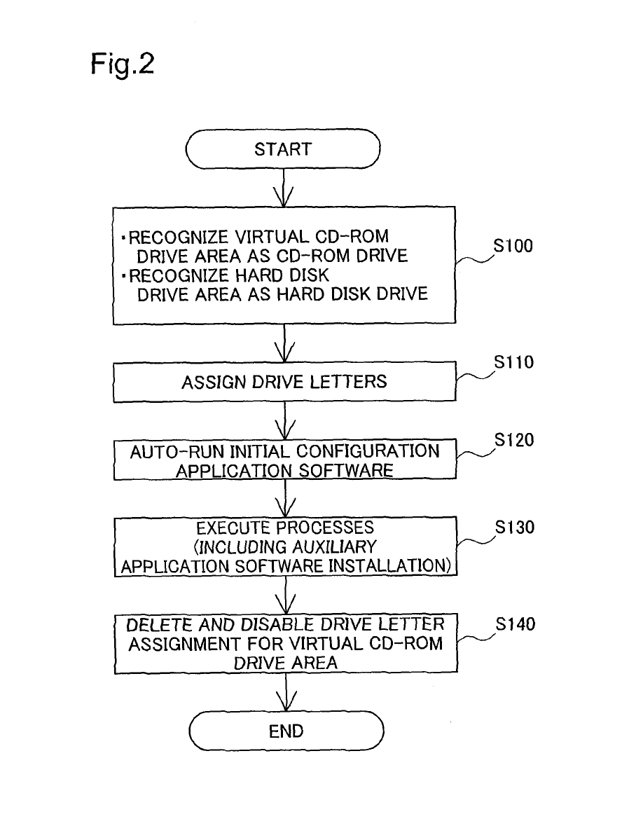

FIG. 2 is a flowchart illustrating the flow of a process executed by the CPU 110 of the personal computer 100 when the hard disk drive 200 is initially connected to the personal computer 100.

When the hard disk drive 200 is initially connected to the personal computer 100, the CPU 110 first recognizes the virtual CD-ROM drive area 222 and the hard disk drive area 224 as a CD-ROM drive and a hard disk drive, respectively (Step S100). The CPU 110 then assigns respective drive letters to the virtual CD-ROM drive area 222 and the hard disk drive area 224 (Step S110). At this time, the CPU 110 records information relating to the drive letter assignments as drive letter information in the registry.

Next, using the Auto-Run function of the OS, the CPU 110 automatically runs the initial configuration application software (launcher) stored in the virtual CD-ROM drive area 222 (Step S120), and accepts commands from the user. In this way the initial configuration application software may be run without the user having to enter an initial configuration application software Run command into the personal computer 100, thus affording enhanced user convenience.

Then, according to commands from the user, the CPU 110 performs various processes such as initial device configuration, RAID configuration, and installation of drivers and application software (Step S130). At this time the CPU 110 also installs the auxiliary application software on the hard disk drive 120. When the process of Step S130 is completed, the CPU 110 executes the auxiliary application software to delete and disable the drive letter assignment for the virtual CD-ROM drive area 222 through a function of the auxiliary application software (Step S140). Deletion of the drive letter assignment for the virtual CD-ROM drive area 222 is accomplished by deleting the information relating to the drive letter assignment for the virtual CD-ROM drive area 222 from the drive letter information described in the registry. Disabling of drive letter assignment for the virtual CD-ROM drive area 222 is accomplished by prohibiting information relating to the drive letter assignment for the virtual CD-ROM drive area 222 from the drive letter information from being described in the registry. The CPU 110 then terminates the process.

Through the above process, the branch in the drive tree and icon representing the virtual CD-ROM drive area 222 no longer appear on the display device 130. Even if the personal computer 100 is restarted with the hard disk drive 200 connected to the personal computer 100, assignment of a drive letter to the virtual CD-ROM drive area 222 is disabled, and because no drive letter is assigned to the virtual CD-ROM drive area 222, no branch in drive tree or icon representing the virtual CD-ROM drive area 222 is displayed on the display device 130.

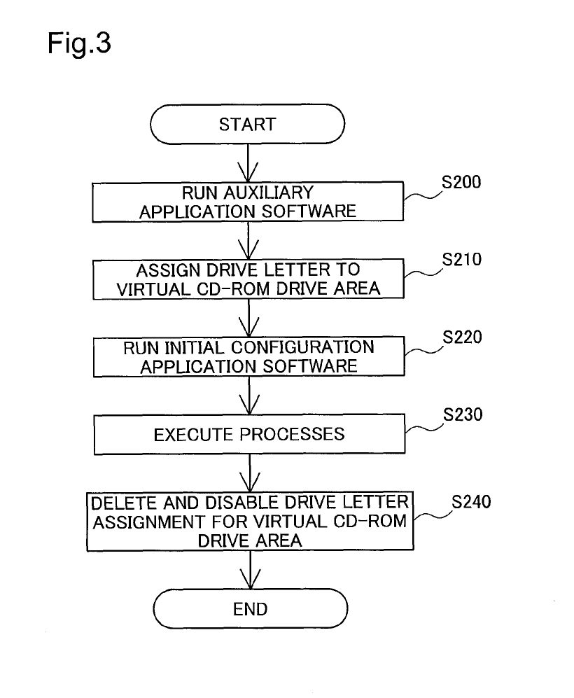

FIG. 3 is a flowchart illustrating the flow of a process executed by the CPU 110 of the personal computer 100 when the initial configuration application software is run the second or subsequent time, with the hard disk drive 200 connected to the personal computer 100.

When the user enters a command to execute the auxiliary application software from the Start Menu of the OS, the CPU 110 runs the auxiliary application software which was installed previously onto the hard disk drive 120 from the virtual CD-ROM drive area 222 (Step S200), and through a function of the auxiliary application software re-enables drive letter assignment for the virtual CD-ROM drive area 222. The CPU 110 then assigns a drive letter to the virtual CD-ROM drive area 222 (Step S210).

Next, the CPU 110 runs the initial configuration application software stored in the virtual CD-ROM drive area 222 (Step S220), and accepts commands from the user. Then, according to commands from the user, the CPU 110 performs various processes such as initial device configuration, RAID configuration, and installation of drivers and application software (Step S230). When the process of Step S230 is completed, the CPU 110 executes the auxiliary application software to again delete and disable drive letter assignment for the virtual CD-ROM drive area 222 through a function of the auxiliary application software (Step S240) in the same manner as in Step S140 of FIG. 2. The CPU 110 then terminates the process.

Through the above process, after the drive letter assignment for the virtual CD-ROM drive area 222 is deleted in the personal computer 100, it is possible for the virtual CD-ROM drive area 222 to be reassigned a drive letter and to be deleted again the drive letter assignment. Accordingly, no branch in the drive tree or icon representing the virtual CD-ROM drive area 222 is displayed on the display device 130 after the completion of the process of Step S230, even when the user or some application software requires the OS to display the drive tree and icons representing the multiple disk drives included in the system.

According to the computer system of the first embodiment described above, when the hard disk drive 200 furnished with the virtual CD-ROM drive area 222 and the hard disk drive area 224 is connected to the personal computer 100, it is possible to hide the branch in the drive tree and icon representing the virtual CD-ROM drive area 222, which need not be displayed on the display device 130, even when the user or some application software requires the OS to display the drive tree and icons representing the multiple disk drives included in the system. This ameliorates cumbersome operation for the user when presented with display of a drive tree and icons representing multiple drive areas on the display device. The user may be provided with enhanced convenience as a result.

### B. Second Embodiment

### B1. System Configuration

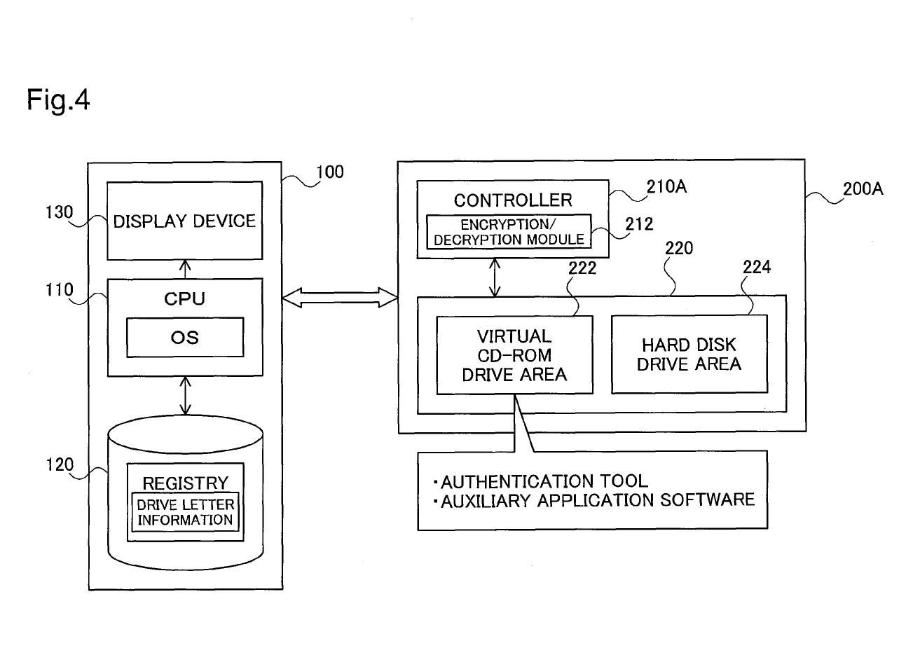

FIG. 4 depicts the general features of a computer system according to a second embodiment of the invention. The configuration of this computer system differs from that in the first embodiment in that the hard disk drive 200 is replaced by a hard disk drive 200A. The hard disk drive 200A is of encrypted hard disk type.

The hard disk drive 200A includes a controller 210A and a storage portion 220. The controller 210A includes an encryption/decryption module 212, and is adapted to decrypt data while reading the data from the storage portion 220, and to encrypt data while writing data to the storage portion 220 (hard disk drive area 224). The encryption/decryption module 212 may be implemented through hardware, or implemented through software. The storage portion 220 includes a virtual CD-ROM drive area 222 and a hard disk drive area 224.

In the hard disk drive 200A of the second embodiment, the virtual CD-ROM drive area 222 stores an authentication tool and auxiliary application software. The authentication tool is a piece of utility software for carrying out password authentication. In the password authentication, an authentication process to determine if a user who wishes to access the hard disk drive 200A is an authorized user is performed. In the present embodiment, password authentication is employed for the authentication process. The authentication tool corresponds to a second computer program recited in the Summary.

As in the first embodiment, the auxiliary application software in the second embodiment has the function of deleting the assignment of a drive letter to the virtual CD-ROM drive area 222. However, in contrast to the first embodiment, the auxiliary application software in the second embodiment does not have the function of disabling assignment of a drive letter to the virtual CD-ROM drive area 222.

### B2. Process

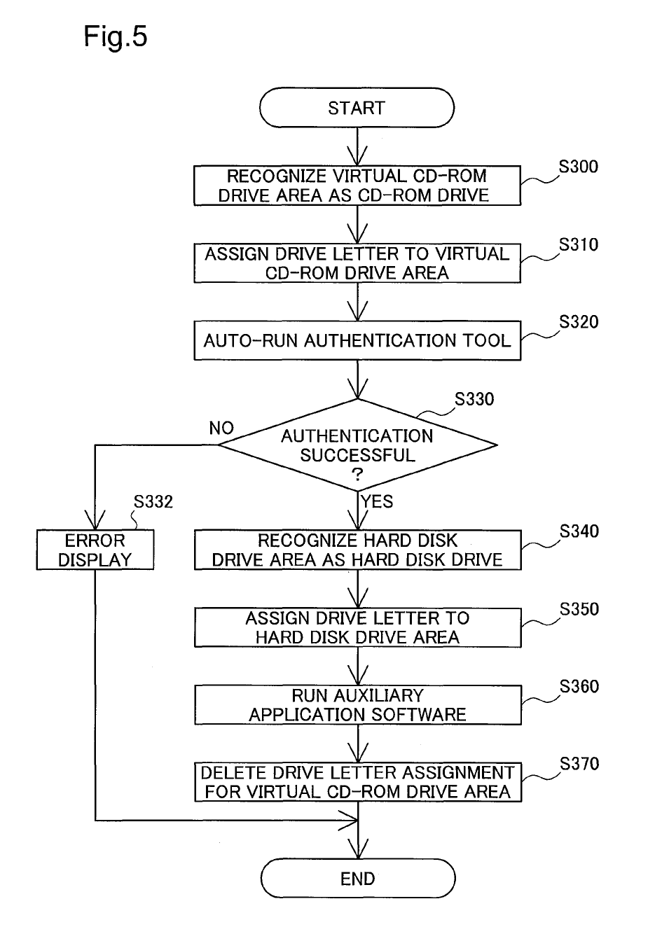

FIG. 5 is a flowchart illustrating the flow of a process executed by the CPU 110 of the personal computer 100 when the hard disk drive 200A is connected to the personal computer 100.

When the hard disk drive 200A is connected to the personal computer 100, the CPU 110 first recognizes the virtual CD-ROM drive area 222 as a CD-ROM drive (Step S300). The CPU 110 then assigns a drive letter to the virtual CD-ROM drive area 222 (Step S310). At this time, the CPU 110 records information relating to the drive letter assignment as drive letter information in the registry. In the present embodiment, recognition of the hard disk drive area 224 and assignment of a drive letter thereto in Steps S300 and S310 are not carried out in contrast to Steps S100 and S110 the first embodiment.

Next, using the Auto-Run function of the OS, the CPU 110 automatically runs the authentication tool stored in the virtual CD-ROM drive area 222 (Step S320), and accepts input of a password by the user. The CPU 110 performs password authentication on the basis of the input password (Step S330), and if authentication fails (Step S330: NO), displays on the display device 130 an error message indicating failed authentication (Step S332). The CPU 110 then terminates the process.

On the other hand if authentication is successful (Step S330: YES), the CPU 110 recognizes the hard disk drive area 224 as a hard disk drive (Step S340), and assigns a drive letter to the hard disk drive area 224 (Step S350). At this time, the CPU 110 records information relating to the drive letter assignment as drive letter information in the registry. Through this feature, until authentication is successful, the hard disk drive area 224 is not assigned a drive letter and the user cannot access the hard disk drive area 224. Thus, only an authorized user can access the hard disk drive area 224.

Next, the CPU 110 runs the auxiliary application software (Step S360), and through a function of the auxiliary application deletes the drive letter assignment for the virtual CD-ROM drive area 222 (Step S370). The CPU 110 then terminates the process. The branch in the drive tree and icon representing the virtual CD-ROM drive area 222 are thus no longer displayed on the display device 130, even when the user or some application software requires the OS to display the drive tree and icons representing the multiple disk drives included in the system.

According to the computer system of the second embodiment described above, when the hard disk drive 200A having the virtual CD-ROM drive area 222 and the hard disk drive area 224 is connected to the personal computer 100, it is possible to hide the branch in the drive tree and icon representing the virtual CD-ROM drive area 222, which need not be displayed on the display device 130. This ameliorates cumbersome operation for the user when presented with display of a drive tree and icons representing multiple drive areas on the display device. The user may be provided with enhanced convenience as a result.

### C. Third Embodiment

### C1. System Configuration

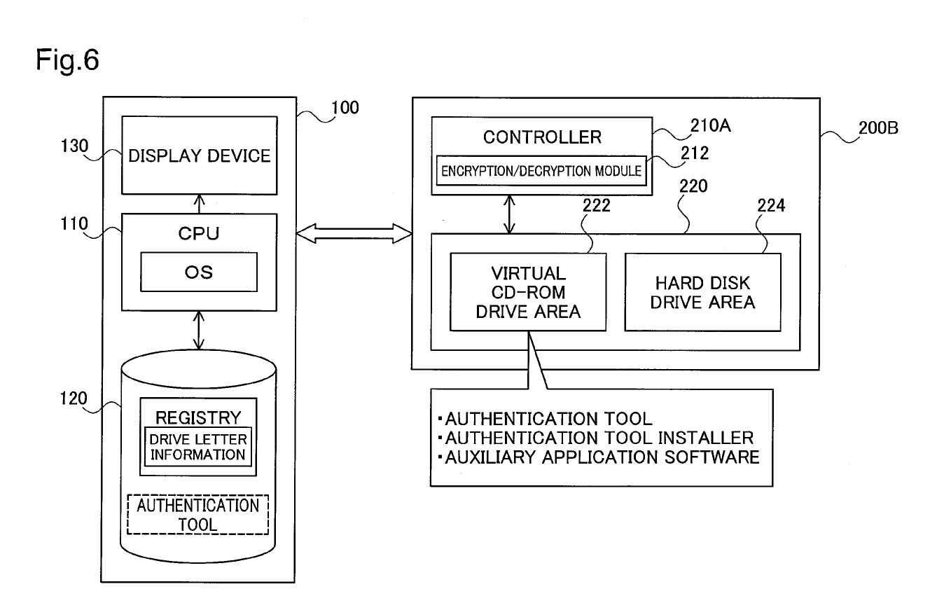

FIG. 6 depicts the general features of a computer system according to a third embodiment of the invention. In this computer system configuration, the hard disk drive 200A of the second embodiment is replaced by a hard disk drive 200B. Like the hard disk drive 200A, the hard disk drive 200B is of encrypted hard disk type. The functions of the various parts of the hard disk drive 200B are identical to those of the hard disk drive 200A.

In the hard disk drive 200B of the third embodiment, the virtual CD-ROM drive area 222 stores an authentication tool installer, in addition to an authentication tool and auxiliary application software. The authentication tool is identical to that in the second embodiment. The auxiliary application software is identical to that in the first embodiment.

### C2. Process

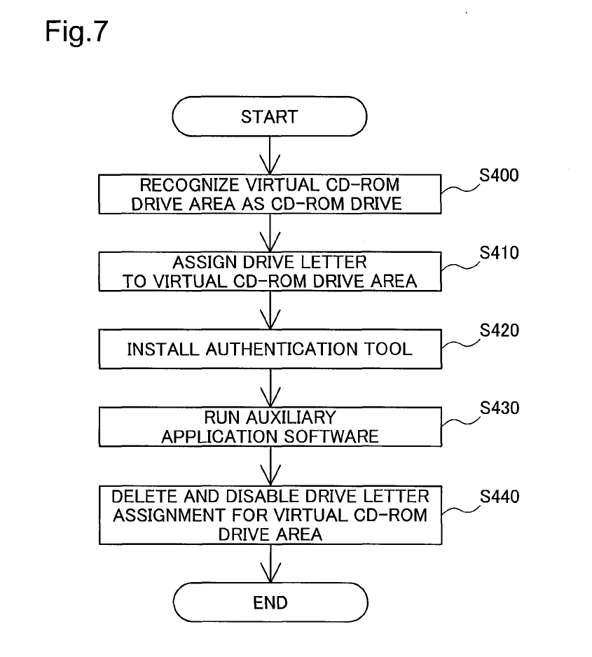

FIG. 7 is a flowchart illustrating the flow of a process executed by the CPU 110 of the personal computer 100 when the hard disk drive 200B is initially connected to the personal computer 100.

When the hard disk drive 200B is initially connected to the personal computer 100, the CPU 110 executes processes identical to Step S300 and Step S310 in FIG. 5 (Steps S400, S410).

Next, using the Auto-Run function of the OS, the CPU 110 automatically runs the authentication tool installer stored in the virtual CD-ROM drive area 222, and installs the authentication tool on the hard disk drive 120 (Step S420). According to this feature, the authentication tool can be run on the personal computer 100 end even after the drive letter assignment for the virtual CD-ROM drive area 222 has been deleted in the personal computer 100. Once installation of the authentication tool is complete, the CPU 110 runs the auxiliary application software (Step S430), and deletes and disables letter assignment for the virtual CD-ROM drive area 222 (Step S440). The CPU 110 then terminates the process.

Through the above process, the branch in the drive tree and icon representing the virtual CD-ROM drive area 222 are no longer displayed on the display device 130. Even if the personal computer 100 is restarted with the hard disk drive 200B connected to the personal computer 100, no drive letter is assigned to the virtual CD-ROM drive area 222, so no branch in the drive tree or icon representing the virtual CD-ROM drive area 222 is displayed on the display device 130.

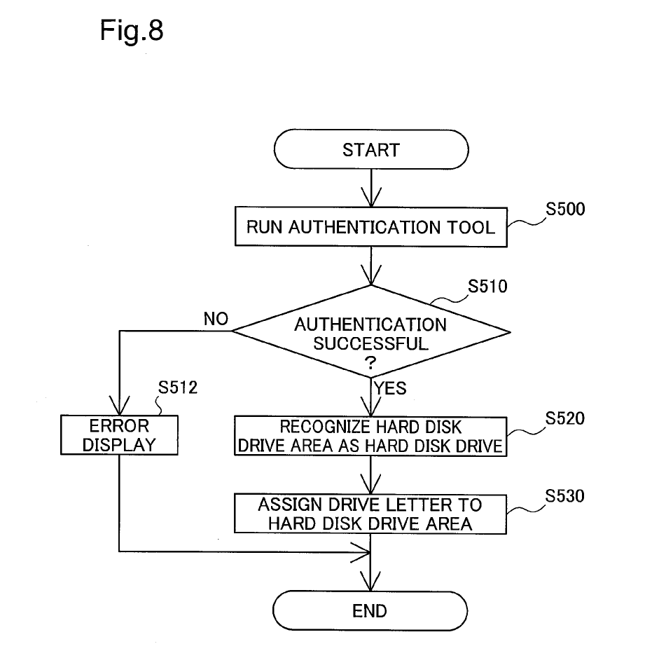

FIG. 8 is a flowchart illustrating the flow of a process executed by the CPU 110 of the personal computer 100 when the hard disk drive 200B is accessed the second or subsequent time.

When the user enters an authentication tool Run command from the Start Menu of the OS, the CPU 110 runs the authentication tool that was previously installed onto the hard disk drive 120 from the virtual CD-ROM drive area 222 (Step S500), and accepts input of a password by the user. The CPU 110 then performs password authentication on the basis of the input password (Step S510), and if authentication fails (Step S510: NO), displays on the display device 130 an error message indicating failed authentication (Step S512). The CPU 110 then terminates the process.

On the other hand if authentication is successful (Step S510: YES), the CPU 110 recognizes the hard disk drive area 224 as a hard disk drive (Step S520), and assigns a drive letter to the hard disk drive area 224 (Step S530). At this time, the CPU 110 records information relating to the drive letter assignment as drive letter information in the registry. The CPU 110 then terminates the process. Through this feature, until authentication is successful, the hard disk drive area 224 is not assigned a drive letter and the user cannot access the hard disk drive area 224. Thus, only an authorized user can access the hard disk drive area 224.

According to the computer system of the third embodiment described above, when the hard disk drive 200B having the virtual CD-ROM drive area 222 and the hard disk drive area 224 is connected to the personal computer 100, it is possible to hide the branch in the drive tree and icon representing the virtual CD-ROM drive area 222, which need not be displayed on the display device 130. This ameliorates cumbersome operation for the user when presented with display of a drive tree and icons representing multiple drive areas on the display device. The user may be provided with enhanced convenience as a result.

### D. Fourth Embodiment

### D1. System Configuration

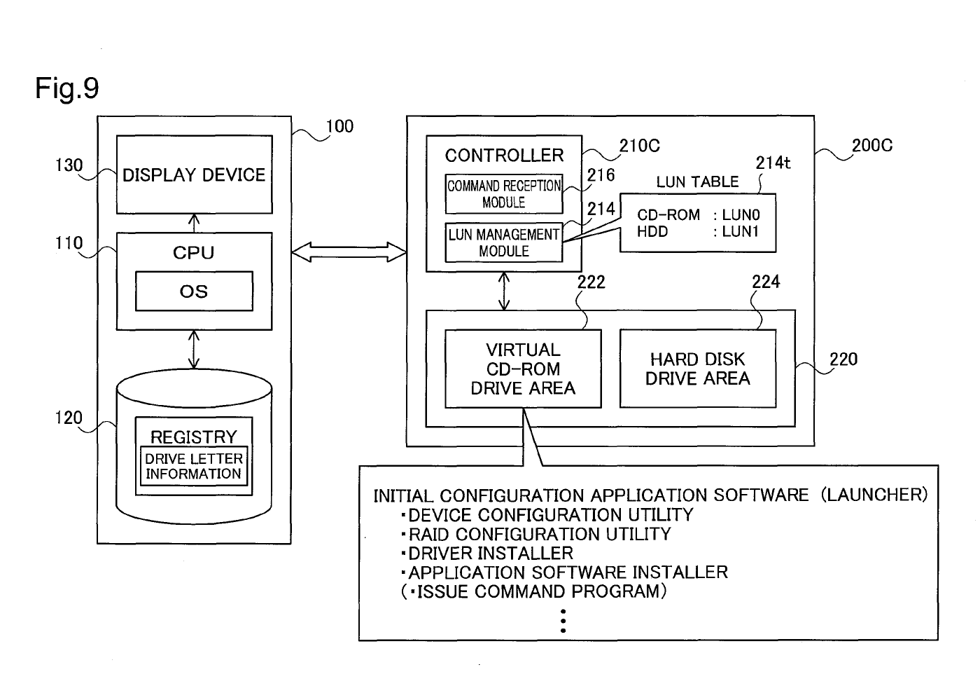

FIG. 9 depicts the general features of a computer system according to a fourth embodiment of the invention. In this computer system configuration, the hard disk drive 200 of the first embodiment is replaced by a hard disk drive 200C.

The hard disk drive 200C includes a controller 210C and a storage portion 220. The controller 210C is furnished with a CPU, RAM, ROM and so on (not shown), a LUN (Logical Unit Number) management module 214, and a command reception module 216. As depicted in model form in the drawing, the LUN management module 214 uses a LUN table 214t to manage information relating to the logical unit number of the virtual CD-ROM drive area 222 and the logical unit number of the hard disk drive area 224. The command reception module 216 receives commands issued by the personal computer 100. The process that employs these elements is discussed later. The LUN table 214t is stored in the EEPROM included in the controller 210C.

As in the first embodiment, the virtual CD-ROM drive area 222 in the hard disk drive 200C of the fourth embodiment stores initial configuration application software, etc. When the hard disk drive 200C is initially connected to the personal computer 100, the initial configuration application software is loaded and executed by the CPU 110 of the personal computer 100. The initial configuration application software in the fourth embodiment includes an Issue Command program in place of the auxiliary application software in the initial configuration application software of the first embodiment. This Issue Command program is a computer program that directs the CPU 110 of the personal computer 100 to issue a command to delete the information relating to the logical unit number of the virtual CD-ROM drive area 222 from the LUN table when the CPU 110 has completed various processes using the initial configuration application software. The hard disk drive area 224 is identical to that in the first embodiment.

### D2. Process

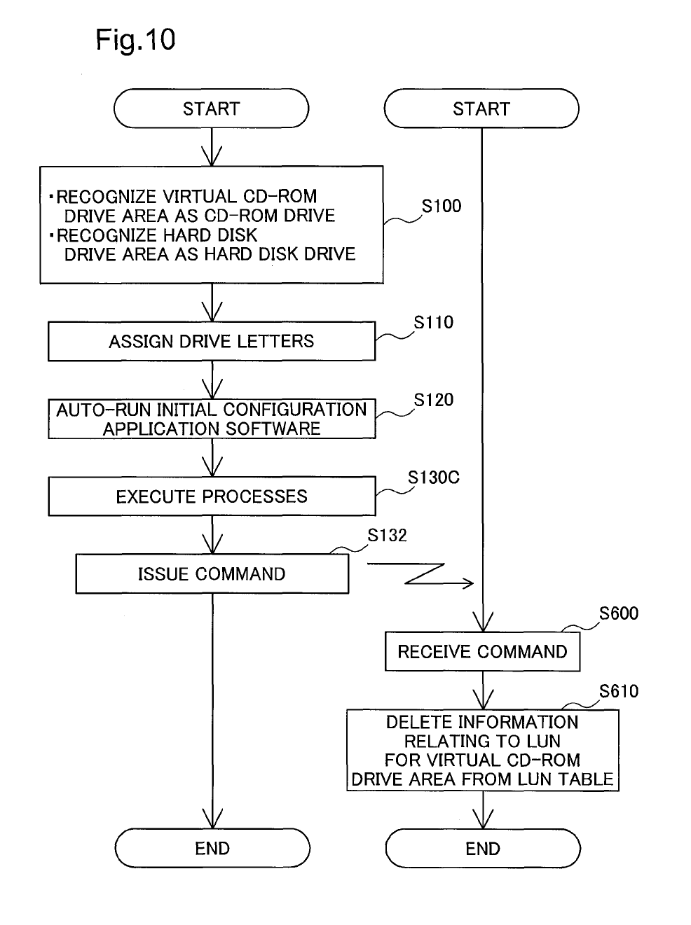

FIG. 10 is a flowchart illustrating the flow of processes executed by the CPU 110 of the personal computer 100 and by the CPU of the controller 210C of the hard disk drive 200C when the hard disk drive 200C is initially connected to the personal computer 100. The process executed by the CPU 110 of the personal computer 100 is shown at left in the drawing, and the process executed by the CPU of the controller 210C of the hard disk drive 200C is shown at right in the drawing.

When the hard disk drive 200C is initially connected to the personal computer 100, first, the CPU 110 of the personal computer 100 executes the processes of Steps S100 to S120 depicted in FIG. 10. These processes are identical to the processes of Steps S100 to S120 shown in FIG. 2. Then, according to commands from the user, the CPU 110 performs various processes such as initial device configuration, RAID configuration, and installation of drivers and application software (Step S130C). At this time, unlike the process of Step S130 in FIG. 2, the CPU 110 does not install the auxiliary application software on the hard disk drive 120. When the CPU 110 completes the process of Step S130C, it then executes the Issue Command program, and issues a command to delete the information relating to the logical unit number of the virtual CD-ROM drive area 222 from the LUN table (Step S132).

When the command reception module 216 of the hard disk drive 200C receives the command (Step S600), the LUN management module 214 deletes the information relating to the logical unit number of the virtual CD-ROM drive area 222 from the LUN table (Step S610). Thus, if the personal computer 100 is restarted with the hard disk drive 200C connected to the personal computer 100, the personal computer 100 cannot recognize the virtual CD-ROM drive area 222 and does not assign a drive letter to the virtual CD-ROM drive area 222, so no branch in the drive tree or icon representing the virtual CD-ROM drive area 222 is displayed on the display device 130.

According to the computer system of the fourth embodiment described above, when the hard disk drive 200C containing the virtual CD-ROM drive area 222 and the hard disk drive area 224 is connected to the personal computer 100, it is possible to hide the branch in the drive tree and icon representing the virtual CD-ROM drive area 222, which need not be displayed on the display device 130. This ameliorates cumbersome operation for the user when presented with display of a drive tree and icons representing multiple drive areas on the display device. The user may be provided with enhanced convenience as a result.

### E. Variations

The present invention may be addressed according to the following aspects of the invention.

### [First Aspect]

According to first aspect of the invention, there is provided:

An external storage device for connection to a computer system, comprising:

a first storage portion storing a first computer program; and

a second storage portion, wherein

the first computer program is to be executed by the computer system after a first drive letter is assigned to the first storage portion by the computer system, and

the first computer program includes:

a portion for directing the computer system to automatically delete the first drive letter assignment for the first storage portion without a Delete instruction by a user at prescribed timing while the external storage device is connected to the computer system.

When the external storage device according to the first aspect is connected to a computer system that includes a display device, the computer system recognizes the first storage portion as a first disk drive, and assigns a first drive letter to the first storage portion. Subsequently, once the computer system loads and executes the first computer program stored in the first storage portion, the first drive letter assignment in the computer system to the first storage portion is deleted automatically. Thus, a branch in the drive tree and icon representing the first storage portion is no longer displayed on the display device. That is, the present aspect ameliorates cumbersome operation for the user when presented with display of a drive tree and icons representing multiple storage portions on a display device, when an external storage device containing the storage portions is connected to a computer system that includes the display device. The user may be provided with enhanced convenience thereby.

In the present aspect, the first storage portion and the second storage portion are mutually different storage portions. Prescribed timing refers to a point in time coming after display of a branch in drive tree and icon representing the first storage portion on the display device is no longer necessary; different timing arrangements may be set up according to how the external storage device is used. The first computer program may be stored in the first storage portion in a format that can be loaded and executed directly by the computer system, or stored in the first storage portion in a compressed format.

### [Second Aspect]

According to second aspect of the invention, there is provided:

The external storage device according to the first aspect wherein

the first computer program further includes:

a portion for directing the computer system to disable assignment of the first drive letter to the first storage portion by the computer system.

According to this feature, if the computer system is restarted while the external storage device is connected to the computer system for example, no first drive letter is assigned to the first storage portion, and thus no branch in the drive tree and icon representing the first storage portion is displayed on the display device.

### [Third Aspect]

According to third aspect of the invention, there is provided:

The external storage device according to the first or second aspect wherein

the first storage portion further stores a second computer program, wherein

the second computer program is to be executed by the computer system after the first drive letter is assigned to the first storage portion by the computer system but before the first computer program is executed by the computer system, and

the second computer program includes:

a portion for directing the computer system to perform a prescribed process in relation to the external storage device according to an instruction from the user, and

the prescribed timing is a timing subsequent to completion of the prescribed process.

According to this feature, the drive letter assignment to the first storage portion may be deleted after the computer system loads and executes a second computer program stored in the first storage portion, and a prescribed process is completed in the computer system.

Examples of prescribed processes include utility software, an installer for application software, initial configuration of the external storage device, authentication processes, and so on. The second computer program may be stored in the first storage portion in a format that can be loaded and executed directly by the computer system, or stored in the first storage portion in a compressed format.

### [Fourth Aspect]

According to first aspect of the invention, there is provided:

The external storage device according to the third aspect wherein

the second computer program is a computer program automatically run by the computer system after the external storage device is connected to the computer system and the first drive letter is assigned to the first storage portion.

According to this feature, the second computer program may be run without the user inputting a Run command for the second computer program into the computer system, thus affording improved convenience for the user.

### [Fifth Aspect]

According to first aspect of the invention, there is provided:

The external storage device according to the third or fourth aspect wherein

the second computer program further includes:

a portion for directing the computer system to recognize the second storage portion as a second disk drive and to assign a second drive letter to the second storage portion, after the computer system carries out the prescribed process.

According to this feature, assignment of a second drive letter to the second storage portion does not take place, that is, the user cannot access the second storage portion, until the computer system completes the process.

### [Sixth Aspect]

According to first aspect of the invention, there is provided:

The external storage device according to the fifth aspect wherein

the prescribed process includes an authentication process to ascertain whether the user is an authorized user.

According to this feature, only an authorized user can access the second storage portion. Examples of authentication processes are password authentication, biometric authentication, IC card authentication, and various other authentication methods.

### [Seventh Aspect]

According to first aspect of the invention, there is provided:

The external storage device according to any of the third to seventh aspects wherein

the second computer program further includes:

a portion for directing the computer system to install at least some of functions of the second computer program to the computer system.

According to this feature, even after the first drive letter assignment for the first storage portion is deleted in the computer system, at least some of the functions of the second computer program may be run on the computer system end.

### [Eighth Aspect]

According to first aspect of the invention, there is provided:

The external storage device according to the seventh aspect including the features of the third and aspects wherein

the some of the functions includes:

a function for directing the computer system to re-enable to assign the first letter drive to the first storage portion after execution of the first computer program.

According to this feature, after the first drive letter assignment for the first storage portion is deleted in the computer system, the first drive letter assignment may be reassigned to the first storage portion.

### [Ninth Aspect]

According to first aspect of the invention, there is provided:

An external storage device for connection to a computer system, comprising:

a first storage portion;

a second storage portion, wherein

a management portion adapted to manage information relating to a logical unit number of the first storage portion; and information relating to a logical unit number of the second storage portion, using a table, wherein

at prescribed timing after the first storage portion is recognized as a first disk drive and the first storage portion is assigned a first drive letter by the computer system, the management portion deletes the information relating to the logical unit number of the first storage portion from the table.

According to this feature, in the event that the computer system is restarted with the external storage device connected to the computer system for example, the branch in the drive tree and icon representing the first storage portion cease to be displayed on the display device. That is, the present aspect ameliorates cumbersome operation for the user when presented with display of a drive tree and icons representing multiple storage portions on a display device when an external storage device containing the storage portions is connected to a computer system that includes the display device. The user may be provided with enhanced convenience thereby.

### [Tenth Aspect]

According to first aspect of the invention, there is provided:

The external storage device according to the ninth aspect further comprising:

a command reception portion adapted to receive from the computer system a command to delete the information relating to the logical unit number of the first storage portion, wherein

the prescribed timing is timing subsequent to reception of the command by the command reception portion.

According to this feature, the management portion may delete information relating to the logical unit number of the first storage portion, at a point in time subsequent to the command reception portion having received the command from the computer system.

### [Eleventh Aspect]

According to first aspect of the invention, there is provided:

The external storage device according to the tenth aspect wherein

the first storage portion stores a computer program, wherein

the computer program is to be executed by the computer system after the first drive letter is assigned to the first storage portion by the computer system, and

the computer program includes:

a portion for directing the computer system to carry out a prescribed process in relation to the external storage device, according to an instruction from a user; and

a portion for issuing the command when the prescribed process is completed.

According to this feature, when the computer system loads and executes the computer program stored in the first storage portion, and the process is completed in the computer system, the computer may then issue the command. Examples of prescribed processes include utility software, an installer for application software, initial configuration of the external storage device, authentication processes, and so on.

### F. Modified Examples

While the invention is disclosed above in terms of certain preferred embodiments, it is to be understood that there is no intention to limit the invention to the embodiments disclosed herein, and that various other modes are possible within the spirit and scope of the invention. Modifications such as the following are possible, for example.

### F1. Modified Example 1

In the preceding embodiments, in Step S120 shown in FIG. 2 for example, the CPU 110 automatically runs the initial configuration application software, but the invention is not limited to this arrangement. The CPU 110 may instead run the initial configuration application software in response to a user command. This applies to automatically running software in the other embodiments as well.

### F2. Modified Example 2

The features of the hard disk drives 200, 200A, 200B in the preceding first to third embodiments may be combined appropriately. For example, the virtual CD-ROM drive area 222 of the hard disk drive 200A in the second embodiment or the virtual CD-ROM drive area 222 of the hard disk drive 200B in the third embodiment may be designed to store the initial configuration application software in the first embodiment. In the third embodiment, the auxiliary application software may be installed together with the authentication tool on the personal computer 100.

### F3. Modified Example 3

The various software applications included among the initial configuration application software in the first and fourth embodiments may be modified appropriately.

### F4. Modified Example 4

In the preceding second and third embodiments, password authentication is employed as the authentication process, but the invention is not limited thereto. Other authentication technologies such as biometric authentication or IC card authentication could be implemented in place of password authentication.

### F5. Modified Example 5

In the preceding first to third embodiments, the CPU 110 deletes the drive letter assignment for the virtual CD-ROM drive area 222 subsequent to installation of the application software and completion of processes such as the authentication process, but the invention is not limited thereto. The CPU 110 may delete the drive letter assignment for the virtual CD-ROM drive area 222 without a Delete command by the user, at any time while the hard disk drive 200, 200A, 200B is connected to the personal computer 100.

### F6. Modified Example 6

In the preceding embodiments, the storage portion 220 of the hard disk drive 200 is furnished for example with a virtual CD-ROM drive area 222 and a hard disk drive area 224, but the invention is not limited thereto. The storage portion 220 may be provided with a plurality of logical or physical storage portions.

### F7. Modified Example 7

In the preceding embodiments, the external storage device of the invention was implemented in a hard disk drive, but the invention is not limited thereto. The external storage device of the invention may be implemented in other types of external storage device such as a USB memory, SSD (Solid State Drive), or multifunction device, rather than a hard disk drive.

### F8. Modified Example 8

Some of the features implemented through hardware in the preceding embodiments could be replaced by software, and conversely some of the features implemented through software could be replaced by hardware.

### F9. Modified Example 9

The Program product may be realized as many aspects. For example:

(i) Computer readable medium, for example the flexible disks, the optical disk, or the semiconductor memories;
(ii) Computer including the computer readable medium, for example the magnetic disks or the semiconductor memories; and
(iii) Computer temporally storing the computer program in the memory through the data transferring means.

### F10. Modified Example 10

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

What is claimed is:

1. An external storage device for connection to a computer system, comprising:
a first storage portion storing a first computer program; and
a second storage portion, wherein
the first computer program is to be executed by the computer system after a first drive letter is assigned to the first storage portion by the computer system, and
the first computer program includes:
a portion for directing the computer system to automatically delete the first drive letter assignment for the first storage portion without a Delete instruction by a user at prescribed timing while the external storage device is connected to the computer system.

2. The external storage device according to claim 1 wherein
the first computer program further includes:
a portion for directing the computer system to disable assignment of the first drive letter to the first storage portion by the computer system.

3. The external storage device according to claim 1 wherein
the first storage portion further stores a second computer program, wherein
the second computer program is to be executed by the computer system after the first drive letter is assigned to the first storage portion by the computer system but before the first computer program is executed by the computer system, and
the second computer program includes:
a portion for directing the computer system to perform a prescribed process in relation to the external storage device according to an instruction from the user, and
the prescribed timing is a timing subsequent to completion of the prescribed process.

4. The external storage device according to claim 3 wherein
the second computer program is a computer program automatically run by the computer system after the external storage device is connected to the computer system and the first drive letter is assigned to the first storage portion.

5. The external storage device according to claim 3 wherein
the second computer program further includes:
a portion for directing the computer system to recognize the second storage portion as a second disk drive and to assign a second drive letter to the second storage portion, after the computer system carries out the prescribed process.

6. The external storage device according to claim 5 wherein
the prescribed process includes an authentication process to ascertain whether the user is an authorized user.

7. The external storage device according to claim 3 wherein
the second computer program further includes:
a portion for directing the computer system to install at least some of functions of the second computer program to the computer system.

8. The external storage device according to claim 7 dependent on claim 3 dependent on claim 2 wherein
the some of the functions includes:
a function for directing the computer system to re-enable to assign the first letter drive to the first storage portion after execution of the first computer program.

9. An external storage device for connection to a computer system, comprising:
a first storage portion;
a second storage portion, wherein
a management portion adapted to manage information relating to a logical unit number of the first storage portion; and information relating to a logical unit number of the second storage portion, using a table, wherein
at prescribed timing after the first storage portion is recognized as a first disk drive and the first storage portion is assigned a first drive letter by the computer system, the management portion deletes the information relating to the logical unit number of the first storage portion from the table.

10. The external storage device according to claim 9 further comprising:
a command reception portion adapted to receive from the computer system a command to delete the information relating to the logical unit number of the first storage portion, wherein
the prescribed timing is timing subsequent to reception of the command by the command reception portion.

11. The external storage device according to claim 10 wherein
the first storage portion stores a computer program, wherein
the computer program is to be executed by the computer system after the first drive letter is assigned to the first storage portion by the computer system, and
the computer program includes:
a portion for directing the computer system to carry out a prescribed process in relation to the external storage device, according to an instruction from a user; and
a portion for issuing the command when the prescribed process is completed.

12. A control method for a computer system, comprising:
after an external storage device having a first storage portion and a second storage portion is connected to the computer system, recognizing the first storage portion as a first disk drive and assigning a first drive letter to the first storage portion; and
at prescribed timing after the first drive letter is assigned to the first storage portion and while the external storage device is connected to the computer system, automatically deleting the first drive letter assignment for the first storage portion without a Delete instruction by a user.

13. A control method for an external storage device having a first storage portion and a second storage portion, and adapted for connection to a computer system, comprising:
using a table, managing information relating to a logical unit number of the first storage portion and information relating to a logical unit number of the second storage portion; and
at prescribed timing after the external storage device is connected to the computer system, the first storage portion is recognized as a first disk drive by the computer system, and the first storage portion is assigned a first drive letter, deleting the information relating to the logical unit number of the first storage portion from the table.

14. A computer program product comprising:
a computer readable medium as a first storage portion of an external storage device having the first storage portion and a second storage portion, the external storage device being adapted for connection to a computer system; and
a computer program stored on the computer readable medium, the computer program comprising:
a portion for directing the computer system, at prescribed timing after the first storage portion is recognized as a first disk drive by the computer system and the first storage portion is assigned a first drive letter, and while the external storage device is connected to the computer system, to delete automatically the first drive letter assignment for the first storage portion without a Delete instruction by a user.

15. A computer program product comprising:
a computer readable medium included in a computer system; and
a computer program stored on the computer readable medium, wherein
the computer system is to be connected to an external storage device including: a first storage portion; a second storage portion; and a management portion adapted to manage, using a table, information relating to a logical unit number of the first storage portion and information relating to a logical unit number of the second storage portion, wherein
the computer program comprises:
a portion for directing the computer system, at prescribed timing after the external storage device is connected to the computer system, the first storage portion is recognized as a first disk drive and is assigned a first drive letter by the computer system, to delete the information relating to the logical unit number of the first storage portion from the table.
